(19) United States
(12) Patent Application Publication
(10) Pub. No.: US 2017/0338707 A1
(43) Pub. Date: Nov. 23, 2017

(54) ROTOR FOR ROTARY ELECTRICAL MACHINE

(71) Applicant: MITSUBISHI ELECTRIC CORPORATION, Chiyoda-ku, Tokyo (JP)

(72) Inventors: Kazuhiro SHONO, Tokyo (JP); Hidyuki NAKAMURA, Tokyo (JP); Yuki TAMURA, Tokyo (JP); Koji MASUMOTO, Tokyo (JP)

(73) Assignee: MITSUBISHI ELECTRIC CORPORATION, Chiyoda-ku, Tokyo (JP)

(21) Appl. No.: 15/523,208

(22) PCT Filed: Dec. 21, 2015
(86) PCT No.: PCT/JP2015/085656

§ 371 Date: Apr. 28, 2017

(30) Foreign Application Priority Data
Dec. 22, 2014 (JP) 2014-258241

(51) Int. Cl. H02K 1/27

(52) U.S. Cl. CPC H02K 1/276

(57) ABSTRACT

Center bridges connecting an inner-circumferential-side core part and an outer-circumferential-side core part are provided so as to divide magnet insertion holes in which magnets forming one pole are inserted, into a plurality of parts in the circumferential direction. Each center bridge is formed in parallel with and line-symmetrically about a pole axis, and in connection portions respectively connected to the inner-circumferential-side core part and the outer-circumferential-side core part, border portions with respect to the magnet insertion holes are formed in an elliptic arc shape having a major axis parallel with the pole axis or in a curved shape obtained by smoothly connecting a plurality of circular arcs of which radiuses of curvature sequentially decrease toward the outer circumference of a rotor core.

### TECHNICAL FIELD

The present invention relates to a rotor of a rotary electrical machine mounted on, for example, an air-conditioner compressor, and in particular, the structure of a rotor having a permanent magnet enclosed, in a core.

### BACKGROUND ART

In a conventional rotary electrical machine, a plurality of magnet insertion holes provided in the radial direction, in a rotor core are each farther divided into a plurality of parts in the circumferential direction. Two center bridges each connecting the inner-circumferential-side core part and the outer-circumferential-side core part are provided which are inclined by 10 to 50 degrees with respect to the pole axis and are line-symmetric about the pole axis. Magnets are provided in the respective magnet insertion holes sandwiching each of the two center bridges. Two of the four border portions of each center bridge with respect to the magnet insertion holes are formed in an elliptic arc shape (see, for example, Patent Document 1).

Owing to the above configuration, the direction of stress acting on each center bridge and the direction of formation of the center bridge coincide with each other, whereby stress distribution can be uniformed,: and a cutting coefficient is reduced, whereby stress concentration can be avoided and the mechanical strength can be improved. As a result, the bridge width can be reduced and thus leakage magnetic flux can be reduced.

### CITATION LIST

### Patent Document

Patent Document 1: Japanese Translation of PCT International Application Publication No. 2013-531462 (paragraphs [0073]-[0077], FIGS. 5-7)

### SUMMARY OF THE INVENTION

### Problems to be Solved by the Invention

By the way, a centrifugal force occurring in the rotor core due to rotation of the rotor originally acts in the pole axis direction. Therefore, each center bridge attempts to become parallel with the pole axis, whereby binding stress acts thereon and the stress concentrates on diagonal two portions of the center bridge. If there is a cutout at the stress concentrated part, for example, if a part having a small radius of curvature is present at a part where a straight portion and a curved portion are connected in a border portion of the center bridge with respect to a magnet insertion hole, the cutout coefficient increases and the stress further concentrates thereon.

Therefore, in the technique described in the above Patent Document 1, the border portion of the center bridge with respect to the magnet insertion hole is formed in an elliptic arc shape, whereby stress concentration due to cutout is reduced. However, the bending stress acting on the center bridge cannot be eliminated, and stress concentration owing to bending remains. Therefore, the width of the center bridges is inevitably set to be comparatively great, to reduce the stress, and as a result, there is a problem that magnetic short-circuit cannot be sufficiently suppressed.

In addition, in the technique described in the above Patent Document 1, since the magnet insertion holes are provided in plural stages along the radial direction, the rigidity of the core reduces as a whole. Therefore, as the rotation rate increases, the core becomes more likely to be deformed by a centrifugal force. It is considered that, as a measure therefor, each center bridge Is formed so as to be inclined with respect to the pole axis. However, the degree of the inclination angle of the center bridges is applicable only to a specific rotation rate, and therefore there is a problem that, in the case of the other rotation rates, it is inevitable that the bending stress still acts on the center bridges.

The present invention has been made to solve the above problems, and an object of the present invention is to obtain a rotor for rotary electrical machine, in which the mechanical strength of the center bridges can be maintained and the center bridge width between the magnet insertion holes can be set to be small, thereby enabling leakage magnetic flux to be reduced more than in the conventional technique.

### Solution to the Problems

A rotor for rotary electrical machine according to the present invention is a rotor for rotary electrical machine of a magnet- embedded type in which a plurality of magnets are enclosed in a rotor core. The rotor core includes an inner-circumferential-side core part and an outer-circumferential-side core part separated from each other by a magnet insertion hole in which each magnet is inserted. At least one center bridge is provided which divides the magnet insertion hole in which the magnet forming one pole is inserted, into a plurality of parts in a circumferential direction, the center bridge connecting the inner-circumferential-side core part and the outer-circumferential-side core part. The magnet insertion holes are formed line-symmetrically about a pole axis, and in the magnet insertion holes, the magnets are arranged line-symmetrically about the pole axis. The center bridge is formed in parallel with and line-symmetrically about the pole axis, and has connection portions respectively connected to the inner-circumferential-side core part and the outer-circumferential-side core part and having border portions with respect to the magnet insertion holes, a shape of each border portion being one of an elliptic arc having a major axis parallel with the pole axis and a curved shape obtained by smoothly connecting a plurality of circular arcs of which radiuses of curvature sequentially decrease toward an outer circumference of the rotor core.

### EFFECT OF THE INVENTION

In the rotor for rotary electrical machine according to the present invention, stress concentration due to bending stress and cutout in the center bridge is avoided and the stress can be substantially equalized over the entire region of the center bridge. Therefore, it is possible to maintain the mechanical strength while reducing the sectional area of the center bridge as compared to the conventional case, and further enhance the effect of suppressing magnetic short-circuit.

### BRIEF DESCRIPTION OF THE DRAWINGS

FIG. 1 is a plan view showing a rotor for rotary electrical machine in embodiment 1 of the present invention.

FIG. 2 is a plan view showing one pole part of the rotor in embodiment 1 of the present invention.

FIG. 3 is an enlarged plan view showing a part indicated by sign A in FIG. 2,

FIG. 4 is a characteristics diagram showing stress distribution in the case where border portions of connection portions of a center bridge with respect to magnet insertion holes are formed in a circular arc shape.

FIG, 5 is a characteristics diagram showing stress distribution in the case where border portions of connection portions of a center bridge with respect to magnet insertion holes are formed in an elliptic arc shape.

FIG. 6 is a characteristics diagram showing stress change at a connection point P1 between a connection portion and a rectangular portion of the center bridge, and at a major-axis end P2 of the elliptic arc of the connection portion, when the aspect ratio of the elliptic arc is changed in the connection portion of the center bridge.

FIG. 7 is an enlarged plan view showing the case where border portions of connection portions of the center bridge with respect to magnet insertion holes are formed in a curved shape,

FIG. 8 is an enlarged plan view showing the vicinity of a center bridge of a rotor for rotary electrical machine in embodiment 2 of the present invention.

FIG. 9 is an enlarged plan view showing the vicinity of a center bridge of a rotor for rotary electrical machine in embodiment 3 of the present, invention.

FIG. 10 is a plan view showing one pole part of a rotor for rotary electrical machine in embodiment 4 of the present invention.

FIG. 11 is a plan view showing one pole part of a rotor for rotary electrical machine in embodiment 5 of the present invention.

FIG. 12 is a plan view showing the entire shape of a rotor for rotary electrical machine in embodiment 6 of the present invention.

FIG. 13 is a plan view showing one pole part of a rotor for rotary electrical machine in embodiment 6 of the present invention.

FIG. 14 is a plan view showing one pole part of a rotor for rotary electrical machine in embodiment 7 of the present invention.

FIG. 15 is a plan view showing one pole part of a rotary core of a rotary electrical machine in embodiment 8 of the present invention.

### DESCRIPTION OF EMBODIMENTS

### Embodiment 1

FIG; 1 is a plan view showing the entire shape of a rotor for rotary electrical machine in embodiment 1 of the present invention.

The rotor for rotary electrical machine in the present embodiment 1 includes a rotor core 1 having a round-shaped outer circumference. The rotor core 1 is formed by stacking thin sheets, such as electromagnetic steel sheets, which are stamped and shaped by press working. Through the press working, magnet insertion holes 5a, 5b, 5c are formed by stamping, along the circumferential direction of the rotor core 1. In addition, through the press working, a shaft insertion, hole 11 is formed by stamping, at the center of the rotor core 1. By the magnet insertion holes 5a, 5b, 5c formed along the circumferential direction, the rotor core 1 is separated into an inner-circumferential-side core part 2 and an outer-circumferential-side core part 3.

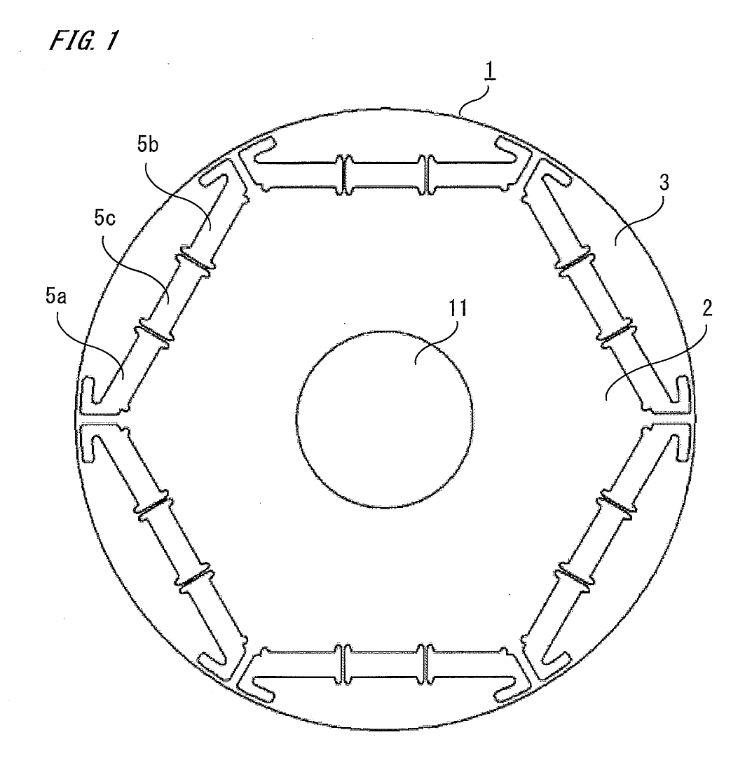

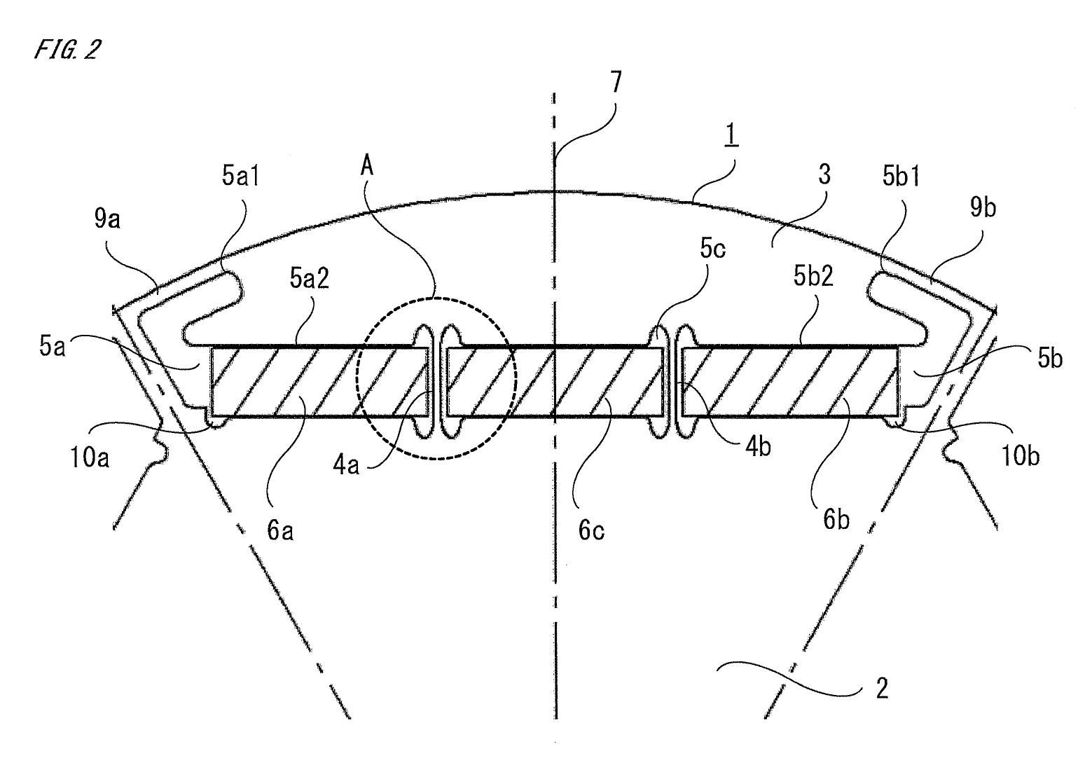

FIG. 2 is an enlarged plan view showing one pole part of the rotor shown in FIG. 1.

In FIG. 2, in the rotor core 1 corresponding to one pole part of the rotor, three magnet insertion holes 5a, 5b, 5c are formed line-symmetrically about a pole axis 7. In this case, the left and right magnet insertion holes 5a and 5b other than the center magnet insertion hole 5c which crosses the pole axis 7 each have an end portion formed substantially in an h shape, at a side opposite to the side facing the center magnet insertion hole 5c. At the boundaries between the L-shaped portions 5a1, 5b1 and the straight portions 5a2, 5b2, magnet stoppers 10a, 10b are formed.

By the magnet insertion holes 5a, 5b, 5c, the rotor core 1 is separated into the inner-circumferential-side core part 2 and the outer-circumferential-side core part 3. The inner-circumferential-side core part 2 and the outer-circumferential-side core part 3 are integrally connected via two center bridges 4a and 4b and outer-circumferential-side bridges 9a and 9b located between poles of magnets. In this case, the center bridges 4a and 4b are formed in parallel with and line-symmetrically about the pole axis 7.

In the respective magnet insertion holes 5a, 5b, 5c, rare earth sintered permanent magnets (hereinafter, referred to as magnets) 6a, 6b, 6c forming one pole and having a plate shape are inserted and arranged in a straight line perpendicular to the pole axis 7 and line-symmetrically about the pole axis 7. The magnets 6a and 6b at both left and right ends are respectively held by the magnet stoppers 10a and 10b so as hot to move in directions perpendicular to the pole axis 7 and away from the pole axis 7.

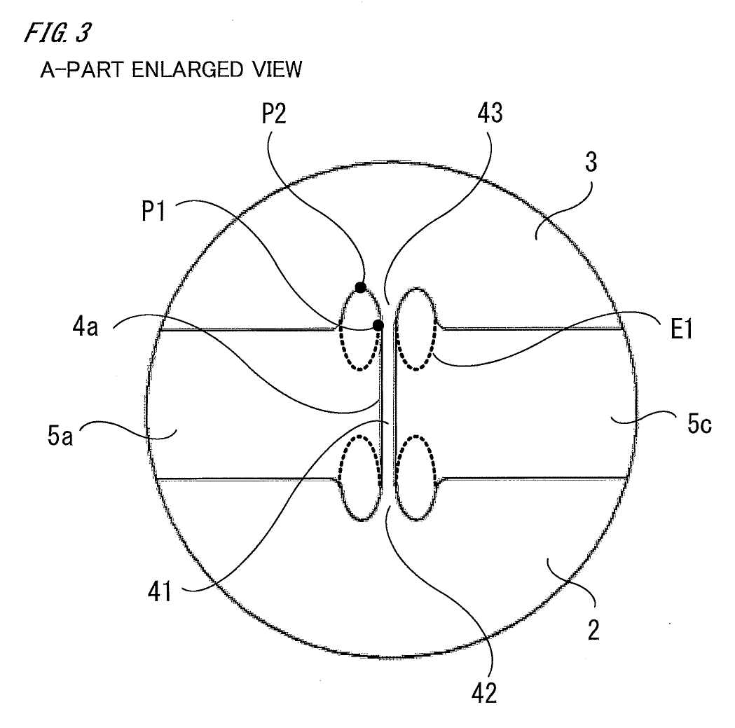

FIG. 3 is an enlarged plan view showing a part indicated by sign A in FIG. 2, i.e., a part corresponding to the center bridge 4a at the left side in FIG. 2.

Here, the center bridge 4a is formed of: a rectangular portion 41 located between facing ends of the pair of magnet insertion holes 5a and 5c and having long-sides: having substantially the same length as the width of the magnet insertion holes 5a and 5c in the direction of the pole axis 7; and connection portions 42 and 43 connected from the rectangular portion 41 respectively to the inner-circumferential-side core part 2 and the outer-circumferential-side core part 3.

In this case, the connection portions 42 and 43 are formed such that their border portions with respect to the magnet, insertion holes 5a arid 5c have an elliptic arc shape which is a part of a virtual ellipse E1 (indicated by broken line in FIG. 3) having a major axis in parallel with the pole axis 7, so as to form recesses in the direction of the pole axis 7 at the facing ends of the magnet insertion holes 5a and 5c. It is noted that the center bridge 4b at the right in FIG. 2 is also formed in the same shape.

In this configuration, when the rotor is rotated, a centrifugal force acts on the outer-circumferential-side core part 3 and the magnets 6a, 6b, 6c. At this time, since the outer-circumferential-side core part 3 is integrally formed and has a shape line-symmetric about the pole axis 7, of the centrifugal force, components perpendicular to the pole axis 7 cancel each other and only a component in the direction of the pole axis 7 occurs.

Similarly, since the center magnet 6c located in the magnet insertion hole 5c on the pole axis 7 has a shape line-symmetric about the pole axis 7, the direction of a centrifugal force acting on the magnet 6c coincides with the direction of the pole axis 7. In addition, also regarding the magnets 6a and 6b at the left and the right of the center magnet 6c, the magnets 6a and 6b having the same shape are located line-symraetrically about the pole axis 7. Therefore, considering a centrifugal force acting on each of the magnets 6a and 6b to be separated into a direction along the pole axis 7 and a direction perpendicular to the pole axis 7, components acting in the direction perpendicular to the pole axis 7 are received by the magnet stoppers 10a and 10b, and only components parallel with the pole axis 7 act on the respective center bridges 4a and 4b, at the same magnitude.

Therefore, it is found that, even if centrifugal forces acting on the outer-circumferential-side core part 3 and the magnets 6a, 6b, 6c are considered in total, the center bridges 4a and 4b only have to support components parallel with the pole axis 7. Needless to say, this condition does not depend on the rotation rate.

Further, in the case where magnet insertion holes and slits are formed in the outer-circumferential-side core part 3 as disclosed in the above Patent Document 1, the rigidity of the outer-circumferential-side core part 3 reduces, so that the outer-circumferential-side core part 3 might be deformed by a centrifugal force and bending stress might act on the center bridges 4a and 4b. In the present embodiment 1, since slits and holes such as magnet insertion holes are not formed in the outer-circumferential-side core part 3, the rigidity of the outer-circumferential-side core part 3 does not excessively reduce.

Thus, it is possible to obtain a state in which forces that are parallel, with the pole axis 7 and have the same magnitude act on the center bridges 4a and 4b and stress in the bending direction does not act thereon. In addition, since the long-sides of the rectangular portions 41 of the center bridges 4a and 4b are parallel with the pole axis 7, stress in each rectangular portion 41 is almost uniformed, and therefore it is possible to reduce the short-side width of the rectangular portions 41, whereby the effect of suppressing magnetic short-circuit is improved.

Here, in FIG. 3, in the case where the direction of stress acting on the center bridge 4a coincides with the longitudinal direction of the center bridge 4a, stress concentration due to a centrifugal force occurs at the following locations. That is, shape change occurs at a connection point between a border portion of the rectangular portion 41 of the center bridge 4a with respect to the magnet insertion hole 5a, 5c and a border portion of the connection portion 42, 43 with respect to the magnet insertion hole 5a, 5c, e.g., a connection point indicated by sign PI in PIG, 3, and therefore stress concentration occurs: at the connection, point. Therefore, in order to reduce stress concentration, shape change at the connection point (for example, sign P1 in FIG. 3) may be made mild, in other words, the radius of curvature may be increased at the connection point.

Here, supposing that the border portion at P1 of each connection, portion 42, 43 of the center bridge 4a with respect to each magnet insertion hole 5a, 5c has not an elliptic arc shape but a circular arc shape, stress concentrates on the connection point between the straight line and the circular arc, so that the connection point can become, a start point of fatigue breakage. In order to prevent this, it is conceivable that the radius of the circular arc is increased to make shape change mild, or the short-side width of the rectangular portion 41 is broadened to reduce average stress. However, if the radius of the circular arc is increased, the core area decreases, resulting in a problem that the magnetic resistance increases. In addition, if the short-side width of the rectangular portion 41 is broadened, magnetic short-circuit increases, and the length of the magnet in the direction perpendicular to the pole axis 7 is shortened, whereby the magnetic property is deteriorated.

In contrast, in the present embodiment 1, since the border portion: of the connection portion 42, 43 with respect to the magnet insertion hole 5a, 5c is formed in an elliptic arc shape having a major axis parallel with the pole axis 7, shape change at the connection point P1 can be made mild, that is, the radius of curvature at the connection point P1 can be increased. Thus, as compared to the case where the border portion of the connection portion 42, 43 to the magnet insertion hole 5a, 5c is formed in a circular arc shape, the cutout coefficient decreases, whereby occurrence of stress concentration can be suppressed, and the above problem as in the case of circular arc shape can be avoided. It is noted that, although the center bridge 4a at the left in FIG. 2 has been described above, the same operation and effect can be obtained also for the center bridge 4b at the right in FIG. 2.

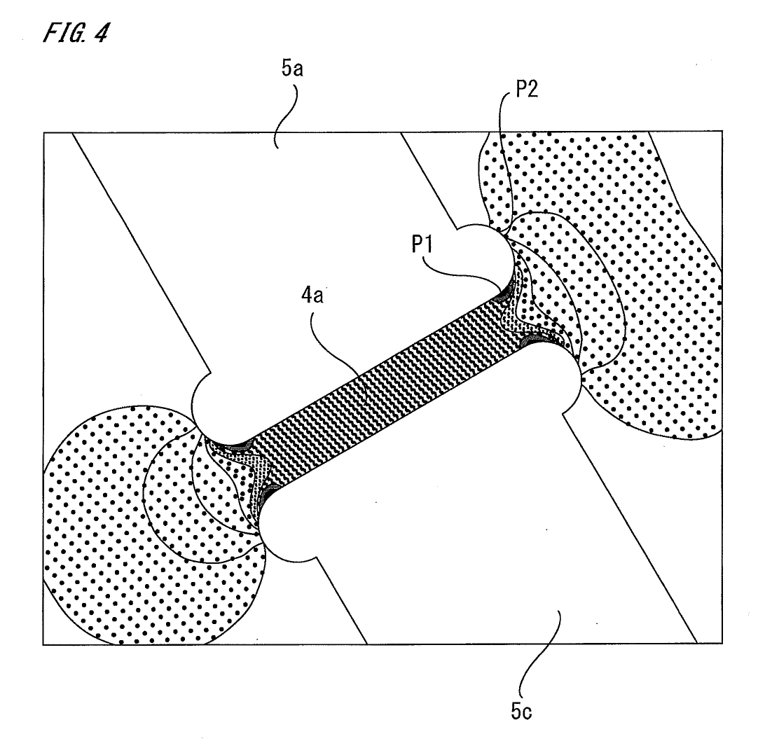

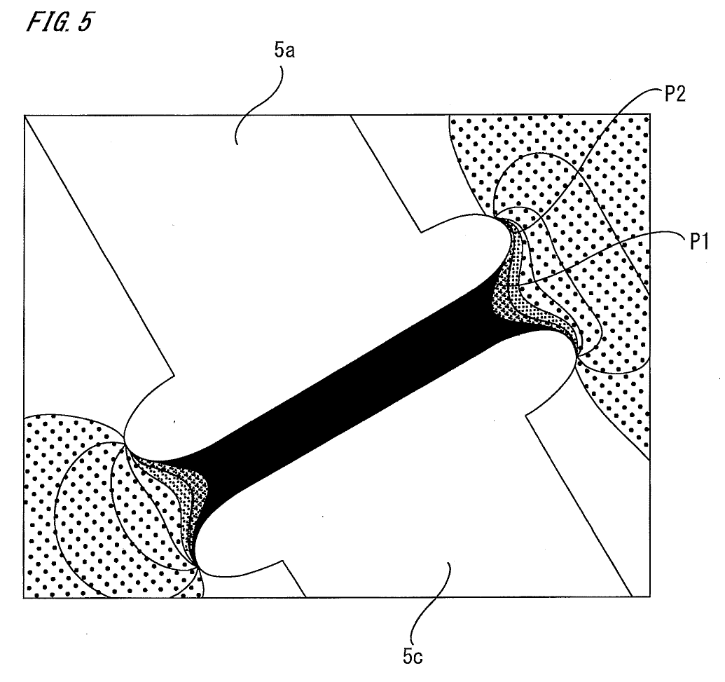

In order to verify this, FIG. 4 and FIG. 5 show results of analysis of stress distribution in the vicinity of the center bridge (for example, center bridge 4a). Here, FIG. 4 shows the case where the border portion of each connection portion 42, 43 with respect to each magnet insertion hole 5a, 5c is formed in a circular arc shape. FIG. 5 shows the case where the border portion of each connection portion 42, 43 with respect to each magnet insertion hole 5a, 5c is formed, in an elliptic arc shape (aspect ratio (major axis/minor axis)=2). In the stress distributions in FIG. 4 and FIG. 5, stress at a black part is the highest, and stress decreases as the density of color decreases.

As is found from FIG. 4 and FIG. 5, in FIG. 4, stress concentrates on the connection point P1 between the straight line and the circular arc. On the other hand, in FIG. 5, it is found that stress does not concentrate on the connection point P1 between the straight line and the elliptic arc, and stress is uniformed.

Thus, since stress is uniformed in the center bridge 4a, if all the border portions of the connection portions 42 and 43 with respect to the magnet insertion holes 5a and 5c have the same shape, the stress concentration states at these portions are substantially the same. Therefore, if the four elliptic arc portions of the connection portions 42 and 43 are ail formed, in the same shape, a good balance is obtained.

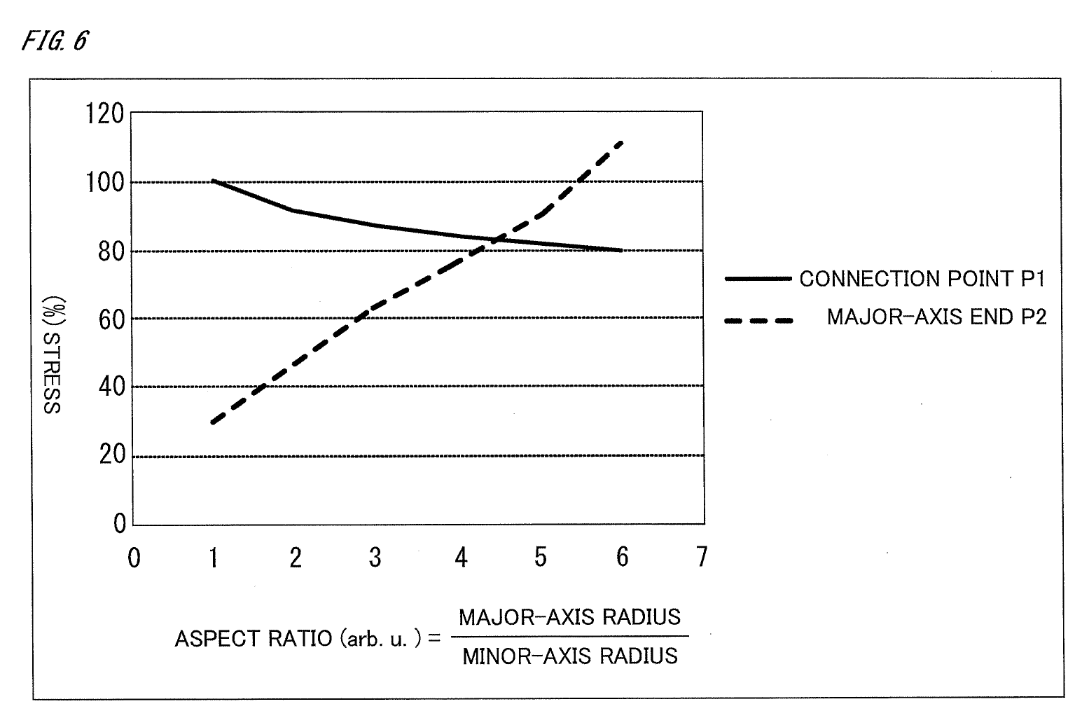

FIG. 6 is an analysis result showing change in stress with respect to change in the aspect ratio (major axis radius/minor axis radius) of the ellipse.

As shown in FIG. 6, at the connection, point P1 between the straight line and the elliptic arc, stress decreases as the aspect ratio increases. On the other hand, at a major-axis end P2 of the elliptic arc, stress increases as the aspect ratio increases, and then exceeds the stress at the connection point P1 when the aspect ratio exceeds approximately 4. Thus, it is found that the aspect ratio of the ellipse is, desirably, not less than 2 and not greater than 4. If the elliptic arc is set within this aspect ratio range (2 to 4), the effect of reducing stress concentration increases. In addition, while the mechanical strength is maintained, the center bridge width can be further narrowed, whereby the effect of suppressing magnetic short-circuit is improved.

In the above description, the shape of the border portion of the connection portion 42, 43 with respect to the magnet insertion hole 5a, 5c is an elliptic arc having a major axis parallel with the pole axis 7, but is not limited thereto. That is, the shape of the border portion of the connection portion 42, 43 with respect to the magnet insertion hole 5a, 5c may be a curved shape 50 obtained by smoothly connecting a plurality of circular arcs of which the radiuses of curvature sequentially decrease toward the outer circumference of the rotor core 1.

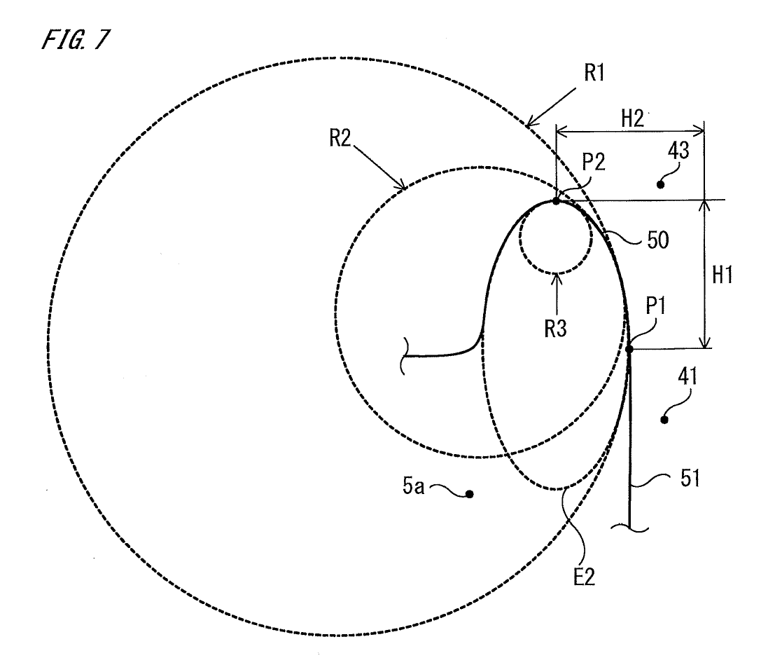

As shown in FIG. 7, at the connection point P1 between a straight border portion 51 which is a border portion of the rectangular portion 41, and a border portion of the connection portion 43, a curved shape tangent to the circular arc (circular arc with radius R1) having the greatest radius of curvature is formed. Then, the border portion of the connection portion 43 with respect to the magnet insertion hole 5a is formed in a curved shape obtained by smoothly connecting a plurality of circular arcs, e.g., a circular arc with a radius R2 and a circular arc with a radius R3, of which radiuses of curvature sequentially decrease.

In this case, if the distance between the connection point P1 and the curve end P2 in a direction parallel with the pole axis 7 is denoted by H1, and the distance between the connection point P1 and the curve end P2 in a direction perpendicular to the pole axis 7 is denoted, by H2, it is preferable that H1/H2 is not less than 2 and not greater than 4, and in this range, the effect of reducing stress concentration can be increased.

In the example in. FIG. 7, three circular arcs having a radius ratio: of R1:R2:R3=4:2:0.5 are prepared, and these three circular arcs are smoothly connected to form the curved shape 50 which is approximate to an ellipse E2 having an aspect ratio (major axis/short axis) of 2.

As described above, in the present embodiment 1, the border portion of the connection portion 42, 43 of each center bridge 4a, 4b with respect to the magnet insertion hole 5a, 5b, 5c is formed in an elliptic arc having a major axis parallel with the pole axis 7, or in a curved shape obtained by smoothly connecting a plurality of circular arcs of which radiuses of curvature sequentially decrease toward the outer circumference of the rotor core 1. Thus, shape change at the connection point P1 can be made mild, and the cutout coefficient decreases, whereby occurrence of stress concentration can be suppressed. As a result, stress can be substantially equalized over the entire region of the center bridge 4a, 4b, and therefore it is possible to maintain the mechanical, strength, while reducing the sectional area of the center bridge 4a, 4b, and further improve the effect of suppressing magnetic short-circuit.

In addition, since the outer-circumferential-side core part 3 has no slit or hole such as a magnet insertion hole, occurrence of bending stress on the center bridge 4a, 4b due to deformation of the outer-circumferential-side core part 3 can foe suppressed.

Further, the long-side of the rectangular portion 41 of the center bridge 4a, 4b has substantially the same length as the width of each magnet insertion hole 5a, 5b, 5c in the direction of the pole axis 7, and the connection portion 42, 43 is formed such that, at the facing ends of the magnet insertion holes 5a and 5c, a recess having the above elliptic arc shape or the above curved shape is formed in the direction of the pole axis 7. Therefore, the length of the magnet 6a, 6b, 6c in a direction perpendicular to the pole axis 7 can be ensured until immediately before the magnet 6a, 6b, 6c comes into contact with the center bridge 4a, 4b, whereby the magnetism quantity can be expected to farther increase.

### Embodiment 2

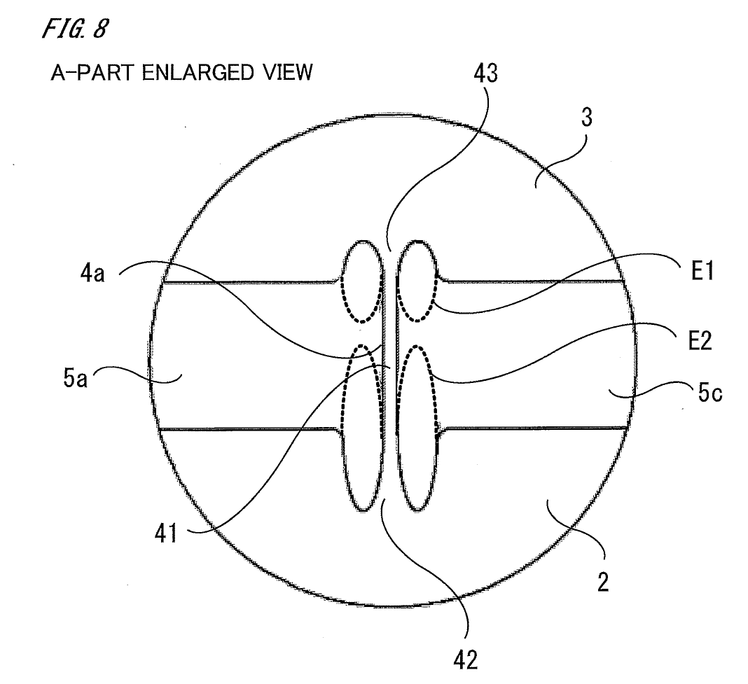

FIG. 8 is an enlarged view (A-part enlarged view in FIG. 2) showing the vicinity of a center bridge of a rotor for rotary electrical machine in embodiment 2 of the present invention. In FIG, 8, components that correspond to or are the same as those in embodiment 1 are denoted by the same reference characters.

In embodiment 2 of the present invention, of the connection portions 42 and 43 of the center bridge 4a, the border portion of the connection portion 4 3 connected to the outer-circumferential-side core part 3 with respect to each magnet insertion hole 5a, 5c is formed in an elliptic arc shape which is a part of a virtual ellipse E1 (indicated by broken line in FIG. 5) having the same aspect ratio as in embodiment 1. On the other hand, the border portion of the connection portion 42 connected to the inner-circumferential-side core part 2 with respect to each magnet insertion hole 5a, 5c is formed in an /elliptic arc shape which is a part of a virtual ellipse E2 having a greater aspect ratio than the above virtual ellipse E1. It is noted, that the elliptic arcs forming parts of the virtual ellipses E1 and E2 are both formed, to have major axes parallel with the pole axis 7.

In the case of using the curved shape 50 obtained by smoothly connecting a plurality of circular arcs, H1/H2 of the curved shape 50 of the border portion of the connection portion 42 connected to the inner-circumferential-side core part 2 is set to be greater than H1/R2 of the curved, shape 50 of the border portion of the connection portion 43 connected to the outer-circumferential-side core part 3.

In the configuration of the present embodiment 2, since the inner-circumferential-side core part 2 has a comparatively large amount of iron and has a sufficient strength, there is almost no influence on the structural strength even though the shape of the recess based on the elliptic arc or curved shape formed at the end of each magnet insertion hole 5a, 5c is enlarged by setting the aspect ratio of the elliptic arc or H1/E2 of the curved shape to be great. Therefore, it is possible to increase the length of the center bridge 4a in the direction of the pole axis 7 while maintaining the structural strength whereby the effect of reducing leakage magnetic flux can be increased.

It is noted that, although the center bridge 4a at the left in FIG. 2 has been described above, the same operation and effect can be obtained also for the center bridge 4b at the right in FIG. 2. The other configuration is the same as in embodiment 1 shown in FIG. 1 to FIG. 3, and therefore the detailed description thereof is omitted here.

### Embodiment 3

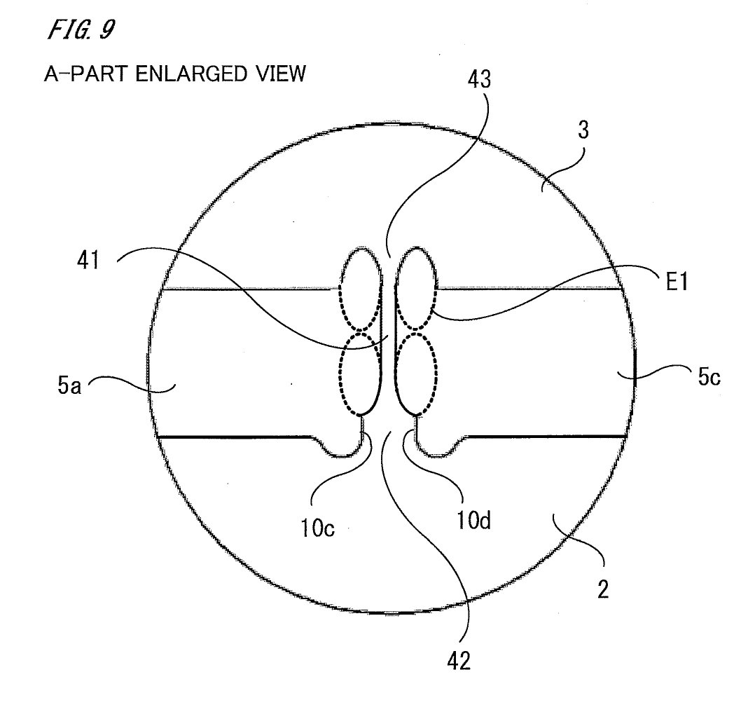

FIG. 9 is an enlarged view (A-part enlarged view in FIG. 2) showing the vicinity of a center bridge of a rotor for rotary electrical machine in embodiment 3 of the present invention. In FIG. 9, components that correspond to or are the same as those in embodiment 1 are denoted by the same reference characters.

In embodiment 3 of the present invention, the center bridge 4a has magnet stoppers 10c and 10d at the border portions of the connection portion 42 connected to the inner-circumferential-side core part 2 with respect to the magnet insertion holes 5a and 5c.

In the configuration of the present embodiment 3, the magnets 6a and 6c do not directly contact the rectangular portion 41 of the center bridge 4a. Therefore, there is no risk of deforming the center bridge 4a by an excessive force being erroneously applied thereto when inserting the magnet 6a, 6c into the magnet insertion hole 5a, 5c of the rotor core 1. Therefore, it is possible, to further redoes the width in the short-side direction of the rectangular portion 41 of the center bridge 4a, whereby the effect of reducing leakage magnetic flux can be increased.

It is noted that the magnet stoppers 10b and 10c may be provided on the connection portion 43 side connected to the outer-circumferential-side core part 3. Although the center bridge 4a at the left in FIG. 2 has been described above, the same applies to the center bridge 4b at the right in FIG, 2. The other configuration is the same as in embodiment 1 shown in FIG. 1 to FIG. 3, and therefore the detailed description thereof is omitted here.

### Embodiment 4

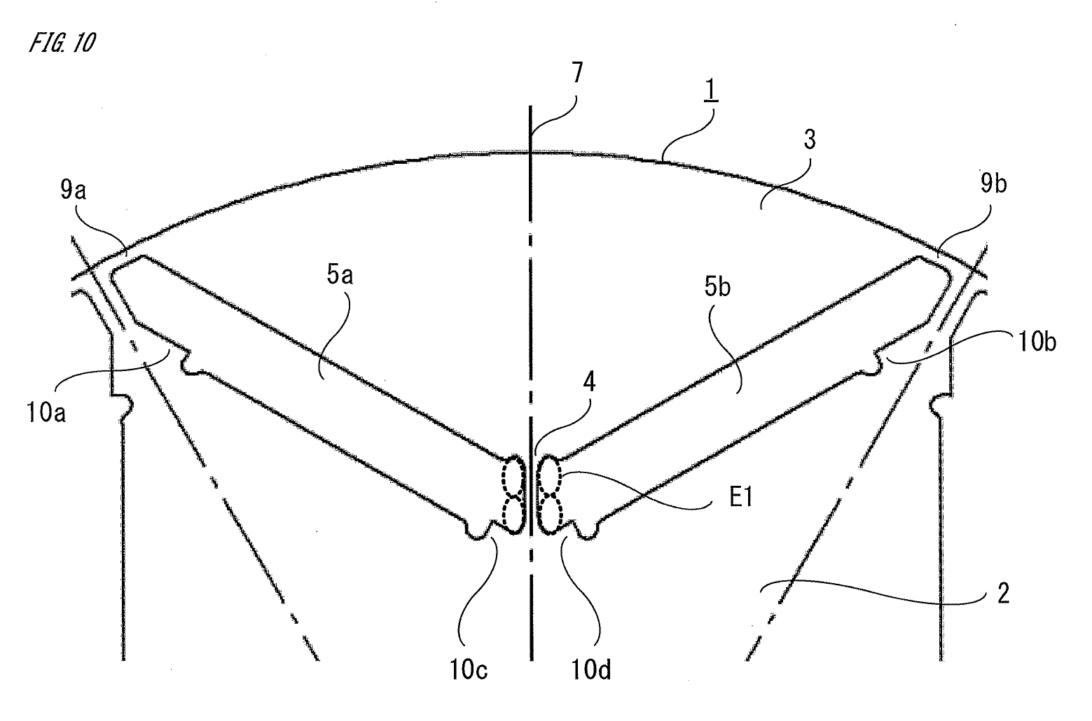

FIG. 10 is a plan view showing one pole part of a rotor for rotary electrical machine in embodiment 4 of the present invention. In FIG. 10, components that correspond to or are the same as those in embodiments 1 to 3 are denoted by the same reference characters.

In embodiment 4 of the present invention, two magnet insertion holes 5a and 5b are formed line-symmetrically about the pole axis 7 and formed in a V shape so as to protrude toward the inner circumferential side of the rotor core 1. Therefore, only one center bridge 4 is formed so as to overlap the pole axis 7. Magnets (not shown) having the same shape are inserted in the respective magnet insertion holes 5a and 5b. It is noted that the shapes and the like of the rectangular portion 41 and the connection portions 42 and 43 of the center bridge 4 are the same as in embodiment 3 shown in FIG. 9, and therefore the detailed description, thereof is omitted here.

In the configuration of the present embodiment 4, as compared to embodiment 1, the length of the magnet insertion hole 5a, 5b can be increased, whereby the inserted magnet amount can be increased. In addition, since the magnets are also arranged line-symmetrically about the pole axis 7, the direction of a centrifugal force acting on the center bridge 4 coincides with the direction of the pole axis 7. Further, the border portions of the connection portions 42 and 43 with respect to the magnet insertion holes 5a and 5b are all formed in a curved shape or an elliptic arc shape having a major axis parallel with the pole axis 7. Therefore, stress concentration is avoided and the stress distribution is uniformed.

As a result, the width of the center bridge 4 in a direction perpendicular to the pole axis 7 can be set to the minimum necessary value, the magnet amount can be increased, and magnetic flux short-circuit at the center bridge 4 can be minimized, whereby a rotor having further high performance can be obtained.

### Embodiment 5

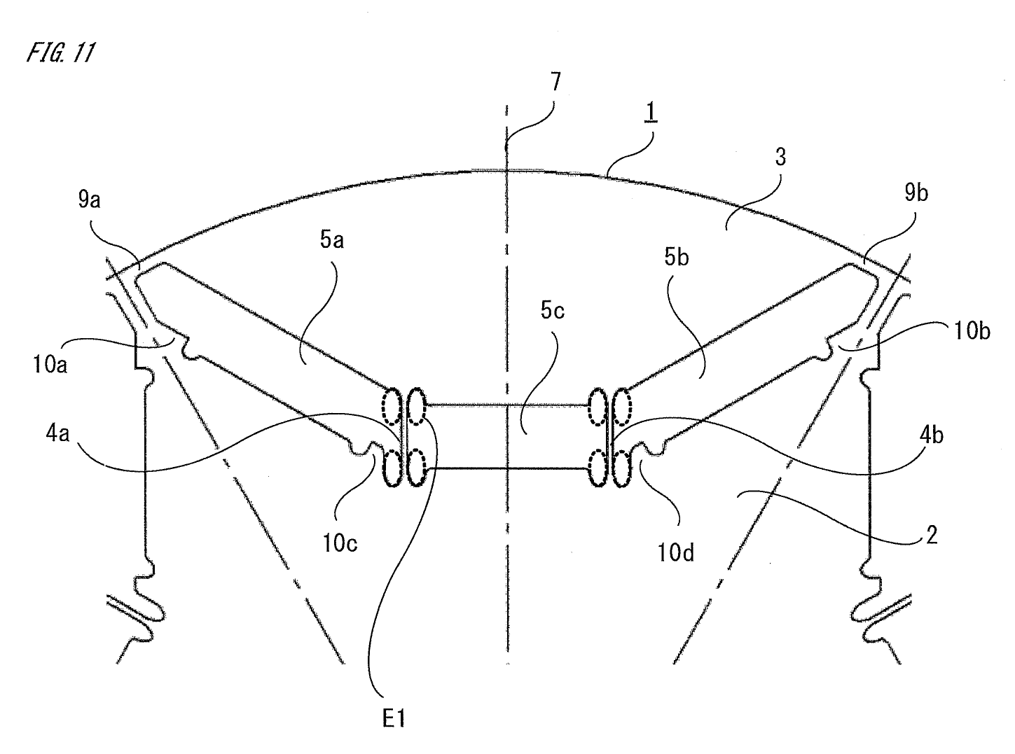

FIG. 11 is a plan view showing one pole part of a rotor for rotary electrical machine in embodiment 5 of the present, invention. In FIG. 11, components that correspond to or are the same as those in embodiments 1 to 4 are denoted by the same reference characters.

In embodiment 5 of the present invention, three magnet insertion holes 5a, 5b, 5c are formed line-symmetrically about the pole axis 7 and formed in a reversed-trapezoidal shape so as to protrude toward the inner circumferential side of the rotor core 1. That is, the center magnet insertion hole 5c perpendicular to the pole axis 7 is formed line-symmetrically about the pole axis 7, and the left and right magnet insertion holes 5a and 5b other than the center magnet, insertion hole 5c are formed line-symmetrically about the pole axis 7 so as to be inclined toward the inner circumferential side of the rotor core 1.

At positions where the magnet; insertion holes 5a and 5c are folded with each other and the magnet insertion holes 5b and 5c are folded with each other, center bridges 4a and 4b are formed in parallel with and line-symmetrically about the pole axis 7. Accordingly, magnets (not shown) for one pole are inserted and arranged in the respective magnet insertion holes 5a, 5b, 5c line-symmetrically about the pole axis 7. Further, the border portions of the connection portions 42 and 43 of the center bridges 4a and 4b with respect to the magnet insertion holes 5a, 5b, 5c are all formed in a curved, shape or an elliptic arc shape having a major axis parallel with the pole axis 7.

In the configuration of the present embodiment 5, as in embodiment 4, the inserted magnet amount can be increased. In addition,, since the magnets are also arranged in parallel with and line-symmetrically about the pole axis 7, centrifugal forces acting on the center bridges 4a and 4b have the same magnitude and the directions of the centrifugal forces coincide with the direction of the pole axis 7. Further, the border portions of the connection portions 42 and 43 with respect to the magnet insertion holes 5a and 5b are all formed in a curved shape or an elliptic arc shape having a major axis parallel with the pole axis 7. Therefore, stress concentration is avoided and the stress distribution, is uniformed. As a result, the width of the center bridge 4a, 4b in a direction, perpendicular to the pole axis 7 can be set to the minimum necessary value, the magnet amount can be increased, and magnetic flax short-circuit at the center bridge 4a, 4b can be minimized, whereby a rotor having further high performance can be obtained.

### Embodiment 6

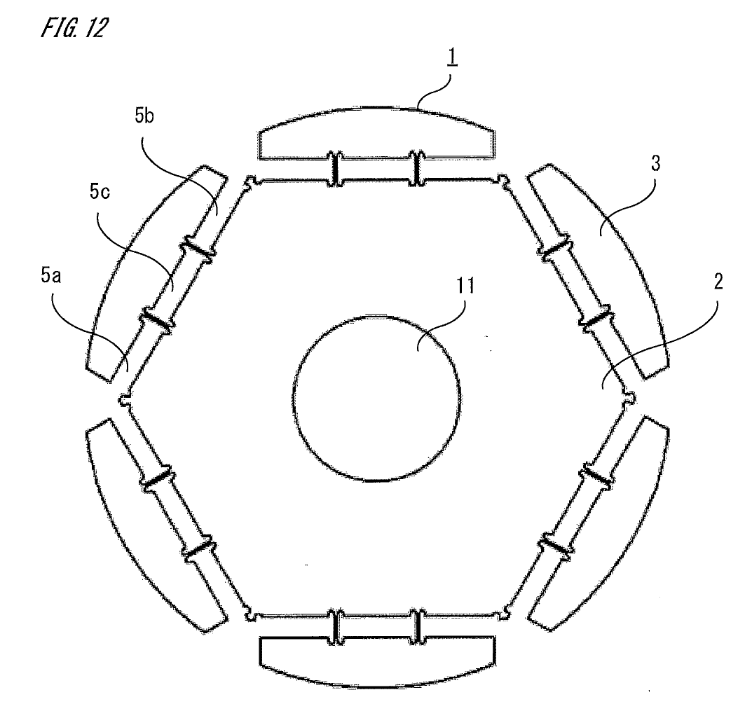

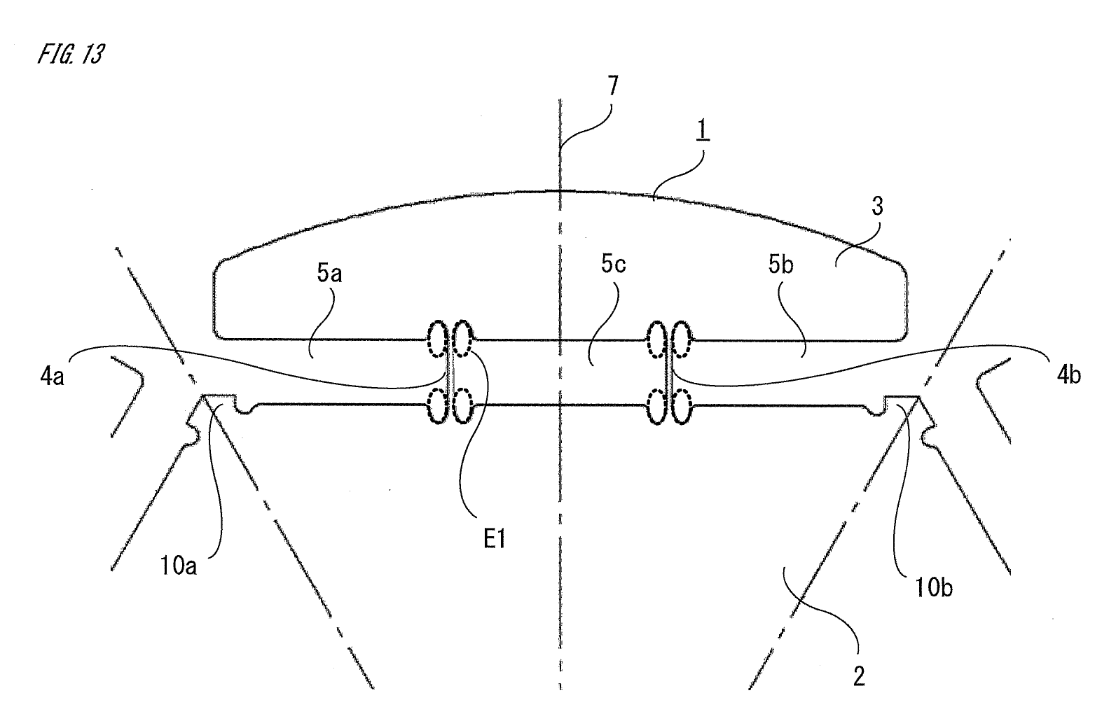

FIG. 12 is a plan view showing the entire shape of a rotor for rotary electrical machine in embodiment 6 of the present invention, and FIG. 13 is a plan view showing one pole part of the rotor for rotary electrical machine in embodiment 6 of the present invention. In FIG. 12 and FIG. 13, components that correspond to or are the same as those in embodiment 1 are denoted by the same reference characters.

In embodiment 6 of the present invention, as in embodiment 1, magnet insertion holes 5a, 5b, 5c formed along the circumferential direction of the rotor core 1. By these magnet insertion: holes 5a, 5b, 5c, the rotor core 1 is separated into the inner-circumferential-side core part 2 and the outer-circumferential-side core part 3. These core parts 2 and 3 are integrally connected via two center bridges 4a and 4b. In this case, the center bridges 4a and 4b are formed in parallel with and line-symmetrically about the pole axis 7.

However, in the present embodiment 6, there are no outer-circumferential-side bridges 9a and 9b located between magnet poles on the outer circumferential side of the rotor core 1 and connecting the inner-circumferential-side core part 2 and the outer-circumferential-side core part 3 as in embodiment 1, but only two center bridges 4a and 4b connect the inner-circumferential-side core part 2 and the outer-circumferential-side core part 3.

It is noted that the shape feature of the center bridges 4a and 4b and the other configuration are the same as in embodiment 1 shown in FIG. 1 to FIG. 3, and therefore the detailed description thereof is omitted here.

In the configuration of embodiment 6, since stress can be substantially equalized over the entire region of the center bridge 4a, 4b, the mechanical strength and the effect of suppressing magnetic flux short-circuit can be maintained while the sectional area of the center bridge 4a, 4b is reduced. In addition, since the outer-circumferential-side bridges are not provided, magnetic flux short-circuit at these locations can be suppressed, whereby a rotor having further high performance can be obtained.

### Embodiment 7

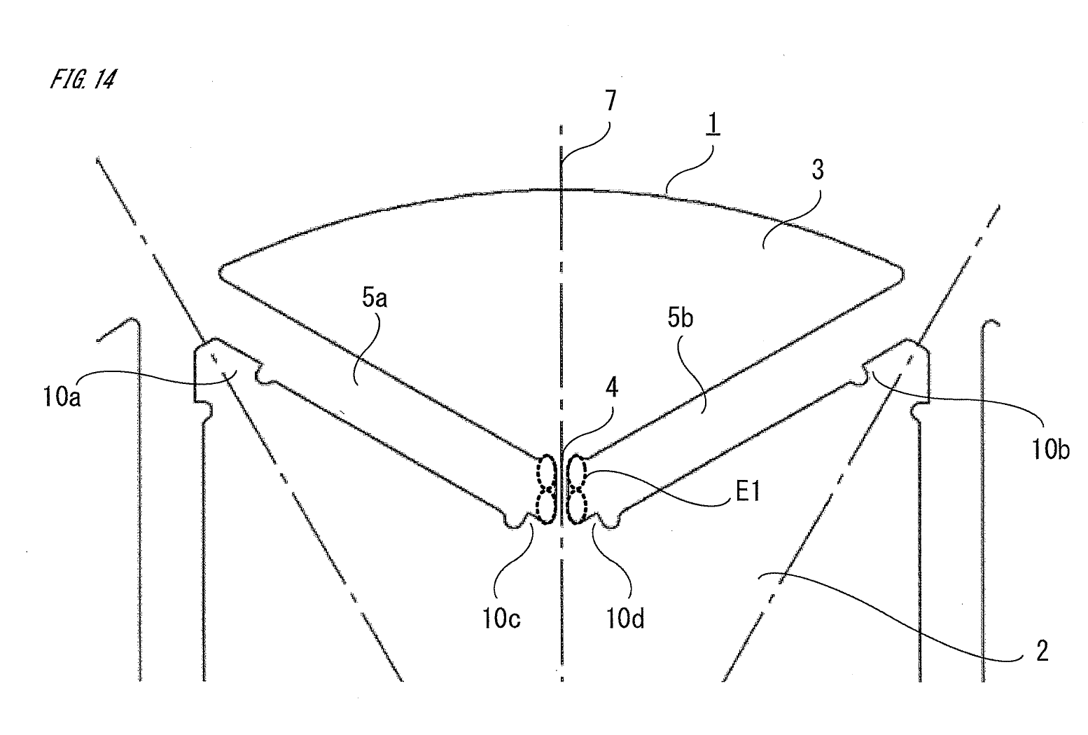

FIG. 14 is a plan view showing one pole part of a rotor for rotary electrical machine in embodiment 7 of the present invention. In FIG. 14, components that correspond to or are the same as those in embodiment 4 are denoted by the same reference characters.

In embodiment 7 of the present invention, as in embodiment 4, the two magnet insertion holes 5a and 5b formed line-symmetrically about the pole axis 7 are formed in a V shape so as to protrude toward the inner circumferential side of the rotor core 1.

However, in the present embodiment 7, there are no outer-circumferential-side bridges 9a and 9b located between magnet poles on the outer circumferential side of the rotor core 1 and connecting the inner-circumferential-side core part 2 and the outer-circumferential-side core part 3 as in embodiment 4, but only one center bridge 4 located on the pole axis 7 connects the inner-circumferential-side core part 2 and the outer-circumferential-side core part 3.

It is noted that the shape feature of the center bridge 4 and the other configuration are the same as in embodiment 4 shown in FIG. 10, and therefore the detailed description thereof is omitted here.

In the configuration of embodiment 7, since stress can be substantially equalized over the entire region of the center bridge 4, the sectional area of the center bridge 4 can be reduced. Therefore, the effect of suppressing magnetic flux short-circuit can be maintained and the inserted magnet amount can be increased, and in addition, since the outer-circumferential-side bridges are not provided, magnetic flax snort-circuit at these locations can be suppressed, whereby 3 rotor having further high performance can be obtained.

### Embodiment 8

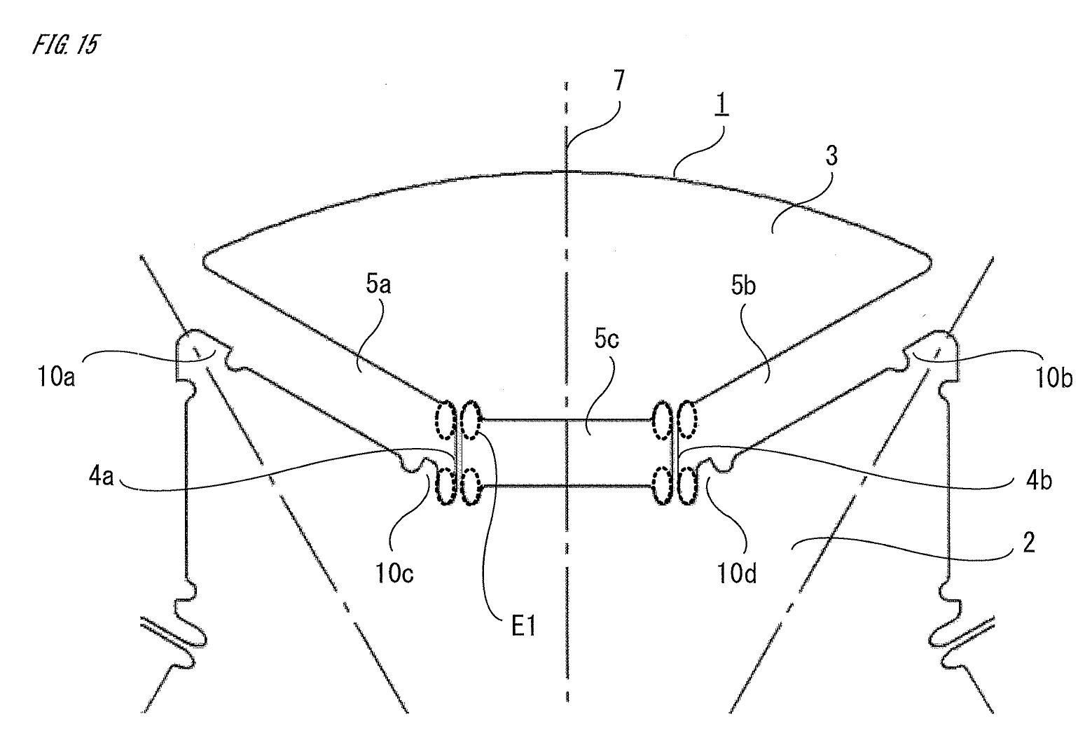

FIG. 15 is a plan view showing one pole part of a rotor for rotary electrical machine in embodiment 8 of the present invention. In FIG. 15, components that correspond to or are the same as those in embodiment 5 are denoted by the same reference characters.

In the present embodiment 8, as in embodiment 5, three magnet insertion holes 5a, 5b, 5c are formed line-symmetrically about the pole axis 7 and formed in a reversed-trapezoidal shape so as to protrude toward the inner circumferential side of the rotor core 1.

However, in the present embodiment 8, there are no outer-circumferential-side bridges 9a and 9b located between magnet poles on the outer circumferential side of the rotor core 1 and connecting the inner-circumferential-side core part 2 and the outer-circumferentlal-side core part 3 as in embodiment 5, but only two center bridges 4a and 4b formed in parallel with the pole axis 7 and line-symmetrically about the pole axis 7 connect the inner-circumferential-side core part 2 and the outer-circumferential-side core part 3.

It is noted that the shape feature of the center bridge 4a, 4b and the other configuration are the same as in embodiment 5 shown in FIG. 11, and therefore the detailed description thereof is omitted here.

In the configuration of embodiment 8, since stress can be substantially equalized over the entire region of the center bridge 4, the mechanical strength and the effect of suppressing magnetic flux short-circuit can be maintained while the sectional area of the center bridge 4a, 4b is reduced. In addition, the inserted magnet amount can be increased, and since the outer-circumferential-side bridges are not provided, magnetic flux short-circuit at these locations can be suppressed, whereby a rotor having further high performance can be obtained.

It is noted that the present invention is not limited to only the configurations of the above embodiments 1 to 8. Without deviating from the gist of the present invention, each configuration of embodiments 1 to 8 may be partially modified or simplified, or the configurations of embodiments 1 to 8 may be combined as appropriate.

For example, in the above embodiments 6 to 8, it is necessary to support the outer-circumferential-side core part 3 and the magnets 6a, 6b, 6c against a centrifugal force, by only the center bridges 4, 4a, 4b, and for the purpose of increasing the strength, it is desirable to use magnetic steel sheets having a high strength (tensile strength of 700 MPa or greater). Needless to say, also in the other embodiments 1 to 5, if the core is formed by magnetic steel sheets having a high strength, the widths of the center bridges 4, 4a, 4b and the outer-circumferential-side bridges 9a, 9b can be further narrowed, whereby the effect of suppressing magnetic short-circuit can be enhanced, in the above embodiments 1 to 8, as an example of the magnets, rare earth sintered permanent magnets having a plate shape have been shown, but magnets of other types or having other shapes may be used.

In the above embodiments 1 to 8, as an example of the shape of the rotor core 1, a six-pole shape has been shown. However, without limitation thereto, a shape corresponding to different number of poles such, as four poles or eight poles is also applicable.

As an example of the shape of the outer circumference of the rotor core 1, a round shape has been shown. However, the same effect is provided also in the case of using other shapes, e.g., a recessed and projecting shape such as a flower-petal shape.

In the above embodiments 1 to 8, an example in which the core is worked by stamping with a press has been shown. However, the same effect is provided also in the case of using other working methods, e.g., cutting or wire cut.

In the above embodiments 1 to 8, application to a rotary electrical machine for compressor has been shown as an example. However, also in the case of rotary electrical machines for other purposes, the present invention is applicable to all types of rotary electrical machines in which magnets are inserted in a rotor core.

1. A rotor for rotary electrical machine of a magnet-embedded type in which a plurality of magnets are enclosed in a rotor core, wherein
the rotor core includes an inner-circumferential-side core part and an outer-circumferential-side core part separated from each other by a magnet insertion hole in which each magnet is inserted,
at least one center bridge is provided which divides the magnet insertion hole in which the magnet forming one pole is inserted, into a plurality of parts in a circumferential direction, the center bridge connecting the inner-circumferential-side core part and the outer-circumferential-side core part,
the magnet insertion holes are formed line-symmetrically about a pole axis, and in the magnet insertion holes, the magnets are arranged line-symmetrically about the pole axis, and
the center bridge is formed in parallel with and line-symmetrically about the pole axis, and has connection portions respectively connected to the inner-circumferential-side core part and the outer-circumferential-side core part and having border portions with respect to the magnet insertion holes, a shape of each border portion being one of an elliptic arc having a major axis parallel with the pole axis and a curved shape obtained by smoothly connecting a plurality of circular arcs of which radiuses of curvature sequentially decrease toward an outer circumference of the rotor core.

2. The rotor for rotary electrical machine according to claim 1, wherein the outer-circumferential-side core part has no hole or slit.

3. The rotor for rotary electrical machine according to claim 1, wherein
in a case where the shape of the border portion of each connection portion of the center bridge with respect to the magnet insertion hole is the elliptic arc, an aspect ratio of the elliptic arc is not less than 2 and not greater than 4.

4. The rotor for rotary electrical machine according to claim 3, wherein
an aspect ratio of the elliptic arc that is the shape of the border portion of the connection portion, of the center bridge, connected to the inner-circumferential-side core part is greater than an aspect ratio of the elliptic arc that is the shape of the border portion of the connection portion, of the center bridge, connected to the outer-circumferential-side core part.

5. The rotor for rotary electrical machine according to claim 1 wherein
in a case where the shape of the border portion of each connection portion of the center bridge with respect to the magnet insertion hole is the curved shape, H1/H2 is not less than 2 and not greater than 4, where H1 is a distance in a direction parallel with the pole axis, between: a connection point between the curved shape and a straight border portion of the center bridge; and a curve end of the curved shape, and H2 is a distance in a direction perpendicular to the pole axis, between the connection point and the curve end.

6. The rotor for rotary electrical machine according to claim 5, wherein
H1/H2 of the curved shape that is the shape of the border portion of the connection portion, of the center bridge, connected to the inner-circumferential-side core part is greater than H1/H2 of the curved shape that is the shape of the border portion of the connection portion, of the center bridge, connected to the outer-circumferential-side core part.

7. The rotor for rotary electrical machine according to claim 1, wherein
the center bridge is formed of: a rectangular portion located between facing ends of a pair of the magnet insertion holes and having substantially the same length as a width in a pole-axis direction of the magnet insertion holes; and the connection portions connected from the rectangular portion respectively to the inner-circumferential-side core part and the outer-circumferential-side core part, and
the border portion of each connection portion with respect to each magnet insertion hole has such a shape that a recess is formed in the pole axis direction of the magnet insertion hole.

8. The rotor for rotary electrical machine according to claim 1, wherein
a magnet stopper for stopping the magnet is formed at the border portion, with respect to the magnet insertion hole, of the connection portion of the center bridge connected to the inner-circumferential-side core part or the outer-circumferential-side core part.

9. The rotor for rotary electrical machine according to claim 1, wherein
a plurality of the magnet insertion holes are formed in a straight line perpendicular to the pole axis.

10. The rotor for rotary electrical machine according to claim 1, wherein
a plurality of the magnet insertion holes are formed in such a shape as to protrude toward an inner circumferential side of the rotor core.

11. The rotor for rotary electrical machine according to claim 1, wherein
between poles of the magnets, an outer-circumferential-side bridge is formed which connects the inner-circumferential-side core part and the outer-circumferential-side core part.

12. The rotor for rotary electrical machine according to claim 1, wherein
the inner-circumferential-side core part and the outer-circumferential-side core part are connected by only the center bridge.

13. The rotor for rotary electrical machine according to claim 1, wherein
the rotor core is formed by stacking a plurality of thin magnetic sheets in a rotation axis direction, and
the thin magnetic sheets are high-strength magnetic steel sheets having a tensile strength of 700 MPa or greater.

14. The rotor for rotary electrical machine according to claim 3, wherein
the center bridge is formed of: a rectangular portion located between facing ends of a pair of the magnet insertion holes and having substantially the same length as a width in a pole-axis direction of the magnet insertion holes; and the connection portions connected from the rectangular portion respectively to the inner-circumferential-side core part and the outer-circumferential-side core part, and
the border portion of each connection portion with respect to each magnet insertion hole has such a shape that a recess is formed in the pole axis direction of the magnet insertion hole.

15. The rotor for rotary electrical machine according to claim 3, wherein
a magnet stopper for stopping the magnet is formed at the border portion, with respect to the magnet insertion hole, of the connection portion of the center bridge connected to the inner-circumferential-side core part or the outer-circumferential-side core part.

16. The rotor for rotary electrical machine according to claim 3, wherein
a plurality of the magnet insertion holes are formed in a straight line perpendicular to the pole axis.

17. The rotor for rotary electrical machine according to claim 3, wherein
a plurality of the magnet insertion holes are formed in such a shape as to protrude toward an inner circumferential side of the rotor core.

18. The rotor for rotary electrical machine according to claim 3, wherein
between poles of the magnets, an outer-circumferential-side bridge is formed which connects the inner-circumferential-side core part and the outer-circumferential-side core part.

19. The rotor for rotary electrical machine according to claim 3, wherein
the inner-circumferential-side core part and the outer-circumferential-side core part are connected by only the center bridge.
